(19) United States
(12) Patent Application Publication
(10) Pub. No.: US 2023/0368366 A1
(43) Pub. Date: Nov. 16, 2023

(54) Systems and Methods for Detecting Boundary Deformations in Transported Items

(71) Applicant: ZEBRA TECHNOLOGIES CORPORATION, Lincolnshire, IL (US)

(72) Inventors: Andrea Mirabile, London (GB); Sam Leitch, Waterdown (CA); Carl ZB. Mower, San Jose, CA (US)

(21) Appl. No.: 17/742,897

(22) Filed: May 12, 2022

(51) Int. Cl. G06T 7/00; G06T 7/13

(52) U.S. Cl. CPC G06T 7/001; G06T 7/13

(57) ABSTRACT

A method in a computing device of detecting boundary deformation for an item includes: obtaining a current image of the item; obtaining, from the current image, a current attribute of a boundary of the item; retrieving a reference attribute of the item boundary, the reference attribute corresponding to the item in an initial state; comparing the current attribute to the reference attribute; determining, based on the comparison, whether the item boundary is deformed relative to the initial state of the item; and when the item boundary is deformed, generating an exception notification.

### BACKGROUND

Transportation and delivery of an item, e.g., the transportation and delivery of a package to a specified destination, may involve a variety of handling stages. For example, the item may be transported from its origin location to a processing facility, prior to being placed on a vehicle. A number of additional stages, each involving additional transport between other facilities, may occur to transport the item to the destination. The number of the above stages, and/or their disparate locations and operating entities, may inhibit the accurate detection of damage to the item and initiation of exception handling processes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for detecting item boundary deformations.

FIG. 2 is a diagram illustrating certain internal components of a client device and a server in the system of FIG. 1.

FIG. 3 is a flowchart of a method for detecting item boundary deformations.

FIG. 4 is a diagram illustrating an example performance of blocks 305, 310, and 315 of the method of FIG. 3.

FIG. 5 is a diagram illustrating an example guide overlay presented during a performance of block 320 of the method of FIG. 3.

FIG. 6 is a diagram of an example performance of block 345 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device of detecting boundary deformation for an item, the method comprising: obtaining a current image of the item; obtaining, from the current image, a current attribute of a boundary of the item; retrieving a reference attribute of the item boundary, the reference attribute corresponding to the item in an initial state; comparing the current attribute to the reference attribute; determining, based on the comparison, whether the item boundary is deformed relative to the initial state of the item; and when the item boundary is deformed, generating an exception notification.

Additional examples disclosed herein are directed to a computing device, comprising: a memory; and a processor configured to: obtain a current image of the item; obtain, from the current image, a current attribute of a boundary of the item; retrieve a reference attribute of the item boundary, the reference attribute corresponding to the item in an initial state; compare the current attribute to the reference attribute; determine, based on the comparison, whether the item boundary is deformed relative to the initial state of the item; and when the item boundary is deformed, generate an exception notification.

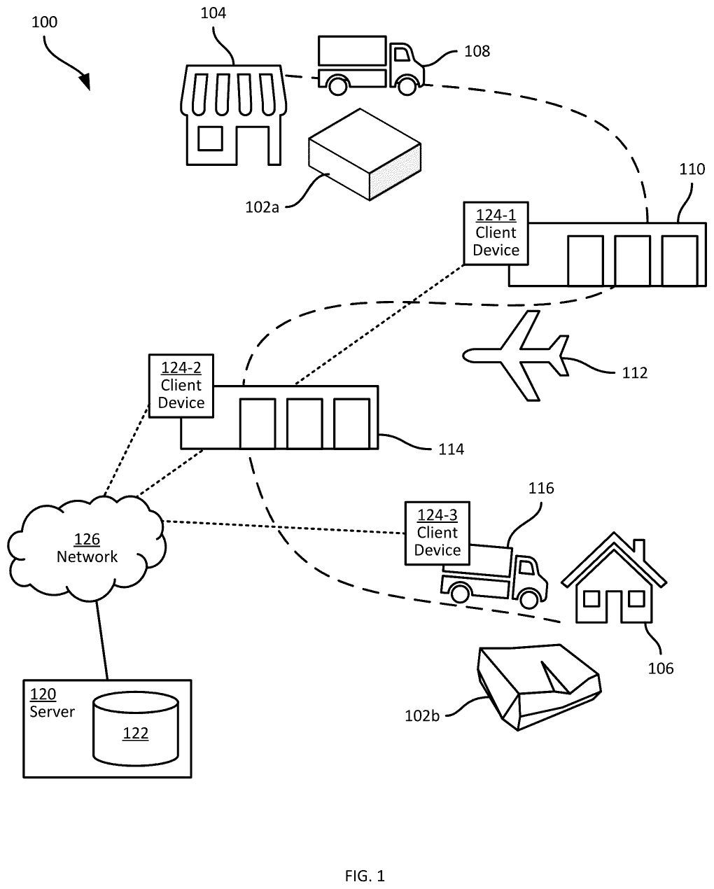

FIG. 1 illustrates a system 100 for detecting boundary deformations in transported items. A wide variety of items, such as packages and other freight, are transported from origin locations to destination locations, often via a variety of intermediate locations. In the illustrated example, an item 102 in an initial state 102a (that is, the character ‘a’ appended to the reference number 102 indicates a particular state of the item 102) may be shipped from a retailer 104 or other entity, for eventual delivery to a destination, such as a customer residence 106. From the retailer 104, the item 102 may be transported (e.g., via a first vehicle 108 such as a truck) to a item handling facility 110 such a warehouse. The item 102 may then, following any suitable processing, sorting and the like at the warehouse 110, be transported (e.g., via a second vehicle 112 such as an aircraft) to a further item handling facility 114, before being transported from the facility 114 to the destination 106 (e.g., via a third vehicle 116).

As will be apparent, the item 102 may take a wide variety of other paths from the retailer 104 to the residence 106, including smaller or greater numbers of intermediate facilities, each implementing varying sets of processing operations on the items handled therein. The item 102, in other words, may pass through a number of distinct intermediate locations, and tens or hundreds of distinct handling steps by numerous individual workers, item handling equipment, and the like. In some cases, items may be damaged during transit. For example, as shown in FIG. 1, the item 102 is shown in a final state 102b at the residence 106, in which the item 102 has sustained deformation (e.g., a crushed and/or torn box). As will be apparent, some item handling systems include tracking of certain item attributes, such as location (e.g., by identifying which facility an item 102 is currently held at) and certain environmental attributes (e.g., by affixing a sensor to an item 102 to log the temperature of the item 102). However, the above attributes do not enable the detection of damage to an item 102 in the form of a deformation of the item's boundary, i.e., damage to one or more outer surfaces of the item 102. Some systems are therefore ill-equipped to initiate exception handling for damaged items 102, e.g., by repackaging such items, rerouting items to inspection facilities, or the like.

To facilitate tracking of the structural integrity of the item 102, enabling the detection of deformation to the boundary of the item 102, the system 100 includes various additional components implementing boundary monitoring functionality, as set out in detail below.

In particular, the system 100 includes at least one computing device, and in the illustrated example, a plurality of computing devices enabled to capture images of the item 102 at various stages of transit between the origin and destination locations, and to process the images to detect boundary deformation of the item 102. In particular, one or more of the computing devices of the system 100 is configured to derive one or more boundary attributes of the item 102 from the images. Attributes derived from a given image or set of images captured at or near the same time (e.g., within a period of one minute or less) can then be compared to corresponding reference attributes, e.g., captured when the item 102 was in the initial state 102a. The comparison may therefore reveal whether the item 102 has been deformed to visible a extent (i.e., such that the deformation is revealed in the images). The computing device(s) of the system 100 can then initiate corrective actions and/or notifications in response to detecting such deformation.

In the illustrated example, the system 100 includes a server 120 storing a repository 122 of tracking data corresponding to the item 102 (and, in some examples, a plurality of other items). The tracking data can include a unique identifier of the item 102, current and past locations and corresponding timestamps for the item 102, and the like. In addition, as will be discussed in detail below, the repository 122 can contain reference attributes representing the visual features of the boundary of the item 102 (e.g., the outer surfaces of a box). The reference attributes are derived from images of the item 102, in the initial state 102a. Storage of the reference attributes enables further attributes, derived from later images of the item 102 during transit, to be compared with the reference attributes in order to detect boundary deformation of the item 102.

The system 100 also includes a plurality of client computing devices configured to capture the above-mentioned images, and in some examples to derive attributes therefrom and perform the above-mentioned comparisons. The client computing devices include, in the illustrated example, a first client device 124-1 associated with the facility 110, a second client device 124-2 associated with the facility 114, and a third client device 124-3 associated with the vehicle 116. The system 100 can include a wide variety of other client devices 124 in other examples, including devices associated with other locations, multiple devices associated with any given location, and the like. In general, the client devices 124 enable the capture of images of the item 102, which in turn enables the derivation of boundary attributes of the item 102 from such images and the detection of boundary deformations indicating damage to the item 102. The client devices 124 and the server 120 are communicatively linked via a network 126, including any suitable combination of local and wide-area networks.

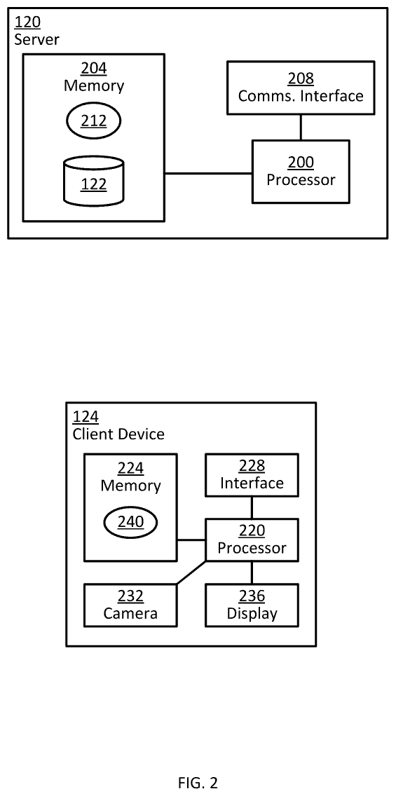

Before discussing the operation of the system 100 in greater detail, certain internal components of the server 120 and an example client device 124 are shown in FIG. 2. In particular, the server 120 includes a processor 200, such as a central processing unit (CPU), graphics processing unit (GPU) or the like, interconnected with a non-transitory computer readable storage medium, such as a memory 204. The memory 204 includes any suitable combination of volatile memory (e.g., Random Access Memory (RAM)) and non-volatile memory (e.g., read only memory (ROM), Electrically Erasable Programmable Read Only Memory (EEPROM), or flash). The processor 200 and the memory 204 each comprise one or more integrated circuits (ICs).

The server 120 also includes a communications interface 208, enabling the server 120 to exchange data with other computing devices, such as the client devices 124, over the network 126. The communications interface 208 therefore includes any suitable hardware (e.g., transmitters, receivers, network interface controllers and the like) and associated firmware and/or software allowing the server 120 to communicate, e.g., over local and/or wide area networks.

The memory 204 stores a plurality of computer-readable instructions, e.g., in the form of applications executable by the processor 200. The applications stored in the memory 204 include a boundary integrity assessment application 212. The application 212 is executable by the processor 200 to implement various functionality performed by the server 120, including the receipt and/or generation of visual attributes of the item 102 for comparison to corresponding attributes from earlier time periods during transit of the item, and detection of boundary deformation of the item 102. The memory 204 can also store the repository 122 mentioned earlier.

The components of the server 120 can be stored in a housing, or distributed across a plurality of housings (e.g., one logical server implemented in various physically distinct enclosures, e.g., for scalability, geographical distribution, or the like). The server 120 can also include, or be connected with, input and output devices such as displays, keyboards, and the like.

As also shown in FIG. 2, the client device 124 includes a processor 220, such as a CPU and/or GPU, connected with a non-transitory storage medium such as a memory 224 (e.g., a suitable combination of volatile and non-volatile memory). The device 124 also includes a communications interface 228 enabling the device 124 to communicate with other computing devices, such as the server 120, over the network 126. The interface 228 can therefore include any suitable hardware and associated firmware and/or software enabling communication over the network 126.

The device 124 also includes at least one camera 232 or other suitable image and/or depth sensor, controllable by the processor 220 to capture one or more images of the item 102. The term “image”, as used herein, includes either or both of color data (including visible light, infrared, and the like) and depth data (e.g., collected via lidar, time-of-flight sensors, or the like). The device 124 can also include a display 236, controllable by the processor 220 to present the above-mentioned captured images, and/or a wide variety of other information including notifications, prompts for input data, and the like. The device 124 can include an input assembly, such as a touch screen integrated with the display 236, a keypad, or any other suitable input device(s). As will be discussed below, the client device 124 can be implemented in a wide variety of form factors, including as mobile and/or wearable devices, fixed devices installed in particular facilities, or the like.

The memory 224 stores applications executable by the processor 220, including a boundary integrity assessment application 240 executable by the processor 220 to implement functionality related to the capture and processing of images of the item 102 to detect boundary deformations. In some examples, such functionality can be implemented in cooperation with the server 120.

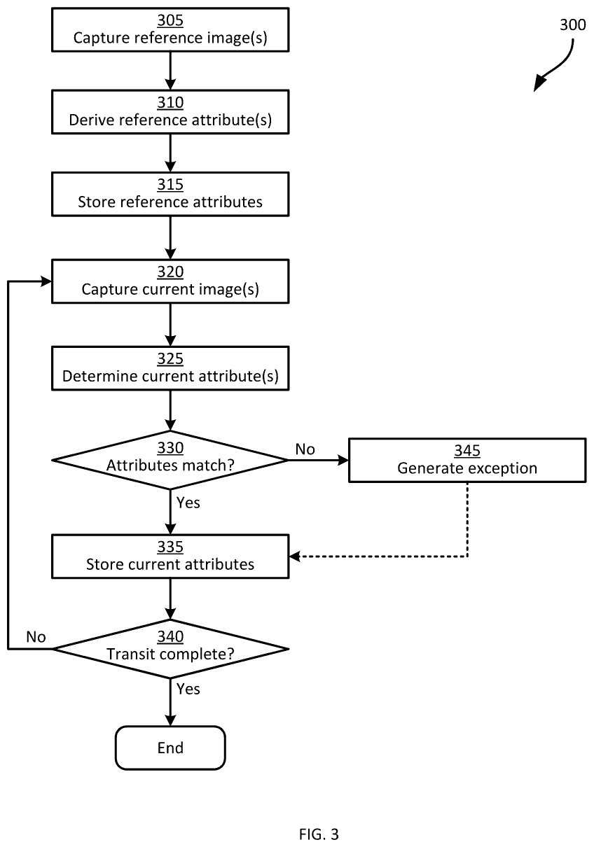

Turning to FIG. 3, a method 300 of detecting boundary deformations in items is illustrated. The method 300 will be described in conjunction with its performance in the system 100, to track the transit of the item 102 and detect boundary deformations thereto. The blocks of the method 300 are described below as being performed by certain components of the system 100 (e.g., the server 120 or a given client device 124). In other examples, however, those blocks of the method 300 can be performed by other computing devices in other implementations. For example, in some embodiments the client devices 124 can act solely to capture images, with the server 120 performing all subsequent processing. In other embodiments, the server 120 can be used solely to store the results of the processing described below, all of which is performed by client devices 124.

At block 305, the client device 124-1 is configured to capture at least one reference image of the item 102, in the state 102a. The reference image depicts at least part of the item 102 in a reference state, i.e., prior to transportation of the item 102 (or at least prior to certain stages of transportation of the item 102). The reference image, in other words, depicts an expected state of the item 102 throughout transportation, in which the item 102 has not suffered any visible damage.

The specific implementation of block 305 varies with the nature of the client device 124-1. For example, when the client device 124-1 is a mobile device such as a smartphone or the like, the client device 124-1 can be manipulated by an operator thereof to position a field of view of the camera 232 so as to encompass the item 102, prior to capturing an image. When the client device 124-1 includes a fixed computing device, e.g., with the camera 232 mounted in a shipping area of a facility or over a conveyor or other item handling apparatus configured to transport the item 102, the item 102 can be placed in the shipping area or on the apparatus, and input can be provided to the client device 124 to activate the camera 232.

At block 310, either of the client device 124 and the server 120 are configured to determine at least one reference attribute of the item (and, as will be apparent in the discussion below, often a plurality of reference attributes), from the image captured at block 305. Determining the reference attributes can therefore be performed at the client device 124 following capture of the reference image. In other examples, the client device 124 can transmit the reference image to the server 120, which can in turn be configured to determine the reference attributes.

More specifically, the reference attribute determined at block 310 is an attribute of the item boundary, i.e., the outermost set of visible surfaces of the item 102. In the illustrated example, the boundary of the item 102 is defined by a box (e.g., a cardboard box containing one or more objects to be shipped), and the reference attribute therefore includes at least one attribute of the box derived from the reference image.

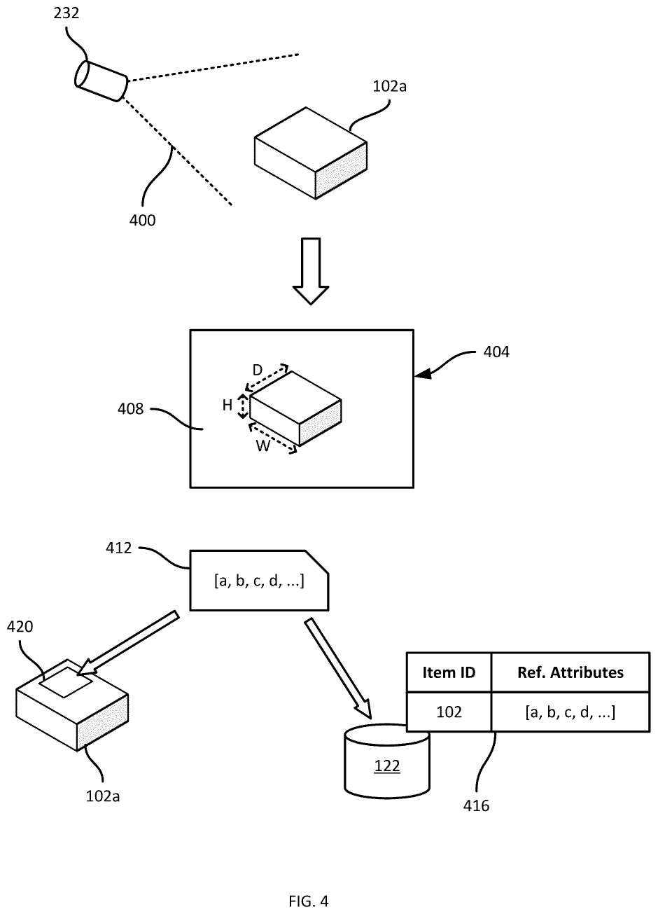

Any one or more of a wide variety of reference attributes can be determined at block 310. In general, the reference attributes are visual attributes of the item 102 that are likely to be altered when the boundary of the item 102 is deformed. That is, in this example the attributes are likely to change if the box is damaged (e.g., a portion of the box is crumpled, torn, abraded, etc.). Various examples of reference attributes will be described below in connection with FIG. 4.

At block 315, the reference attribute(s) derived from the reference image(s) captured at block 305 are stored. Storage of the reference attributes includes, in this example, storage in the repository 122. Thus, in examples in which the client device 124 determines the reference attributes from the reference image, the client device 124 can then transmit the reference attributes to the server 120, via the network 126, for storage in the repository 122. In general, the reference attributes are stored in association with a unique identifier of the item 102, such as a tracking number or the like. In other examples, storage of the reference attributes can include, instead of or in addition to storage in the repository 122, encoding of the reference attributes in a machine-readable indicium such as a barcode, radio identification (RFID) tag, or the like, which is then affixed to the item 102 itself.

Turning to FIG. 4, an example performance of blocks 305, 310, and 315 is illustrated. In particular, the camera 232 of the client device 124-1 is illustrated, positioned so as to locate the item 102 (in the initial state 102a) within a field of view (FOV) 400 of the camera 232. The processor 220 of the client device 124-1 can then control the camera 232 to capture an image 404 depicting the item 102.

Having captured the image 404, the client device 124-1 can either transmit the image 404 to the server 120 for determination of reference attributes, or the client device 124-1 can determine the reference attributes locally. In either case, the relevant processor is configured to determine a preconfigured set of reference attributes from the image 404. In order to determine the reference attributes, the item 102 can be segmented from the remainder of the image 404, e.g., by detecting and removing a background 408 from the image 404, according to any available mechanisms (e.g., via connected components, or the like).

Examples of reference attributes include dimensions of the item 102 derived from the image 404, e.g., via suitable photogrammetry processes, depth data (if the camera 232 captures depth measurements), or the like. For example, the client device 124-1 can determine a height dimensional attributes can also be determined at block 310, including for example surface area, volume, and the like.

The reference attributes can include, in addition to or instead of the dimensions mentioned above, attributes based on detected vertices and/or edges of the item 102. For example, a count of detected edges can be employed as a reference attribute. In other examples, the angles of detected edges can be employed to generate one or more reference attributes. For example, the client device 124-1 can be configured to identify edges of the item 102, and to group the identified edges into sets containing edges with similar angles. A reference attribute in such an example can include a vector representation of a histogram of edge angles (e.g., with each value in the vector representing the number of detected edges having angles within a certain range).

Other examples of reference attributes include color histograms, average color values, or the like, derived from the image 404. Still other examples of reference attributes include keypoint descriptors, in the form of vector representations of regions of the image 404 that exhibit specific characteristics that are likely to remain identifiable independently of the orientation of the item 102, lighting conditions of subsequent images, scaling in subsequent images, and the like. A wide variety of mechanisms for identifying such keypoints will be apparent to those skilled in the art, including for example the ORB (Oriented FAST, Rotated BRIEF) keypoint identification algorithm. Such mechanisms may identify large numbers of keypoint descriptors (e.g., hundreds, in some examples), and the client device 124-1 can retain a predefined subset of such descriptors. In other examples, all identified keypoints can be retained as reference attributes. As will be apparent to those skilled in the art, such keypoint identification algorithms are likely to identify portions of the item 102 with distinctive gradients, edges, or the like, such as portions of a logo or other indicia imprinted on the item 102.

The reference attributes determined at block 310 can be expressed in various forms. For example, the reference attributes can be concatenated in a vector 412, e.g., with the first three values representing the height, width, and depth of the item 102 respectively, followed by values representing a number of edges detected in the image 404, one or more keypoint descriptor vectors, or the like. In other examples, the reference attributes need not be concatenated as mentioned above. In some examples, the reference attributes can be generated via one or more embedding processes, e.g., to reduce the dimensionality of large feature vectors.

Having obtained reference attributes at block 310, the client device 124-1 can store the reference attributes at block 315, e.g., by transmitting the vector 412 to the server 120 for storage in a record 416 of the repository 122. The record 416 can include an identifier of the item 102, as noted earlier, to facilitate subsequent retrieval of the reference attributes during performance of the method 300. In some examples, the image 404 itself can also be stored in the record 416. The record 416 can also contain various other information corresponding to the item 102, such as locations, timestamps, other physical attributes such as the weight of the item 102, and the like.

In some examples, instead of or in addition to storage via the repository 122, storing the reference attributes at block 315 can include encoding the reference attributes in a machine-readable indicium such as a barcode (e.g., a two-dimensional barcode or the like) on a label 420 affixed to the item 102. The reference attributes can also be stored in an RFID tag or the like affixed to the item 102 (e.g., as a component of the label 420). That is, the reference attributes can be stored either or both of centrally (in the repository 122), and locally (affixed to the item 102 itself).

Although a single reference image 404 is shown in FIG. 4, a plurality of reference images can be captured at block 305, and the reference attributes can be derived from the plurality of images. In some examples, a client device 124 can include multiple cameras, e.g., positioned at various locations in a shipping area of a facility and controllable to capture distinct images of the shipping area substantially simultaneously. In other examples, the client device 124 can be manipulated, e.g., by an operator thereof, to capture the images in sequence, repositioning the device 124 or the item 102 between captures. When more than one reference image is available, the images can be registered with each other, e.g., to generate a three-dimensional model of the item 102 from which the reference attributes can be determined.

Returning to FIG. 3, at block 320 it is assumed that the item 102 has been transported from the retailer 104 to an intermediate location such as the facility 110. At the intermediate location, a client device 124 (potentially, although not necessarily, the same client device 124 used to capture the reference images at block 305) is configured to capture one or more current images of the item 102. The capture of images at block 320 is as described above in connection with block 305, with the exception that the images captured at block 320 are captured at a later point in time than the reference images.

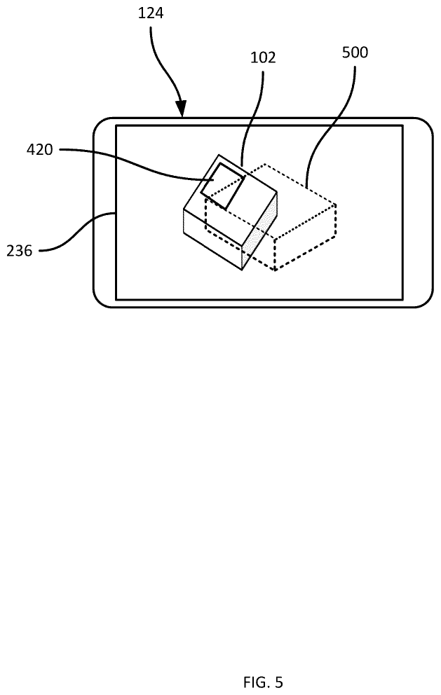

As will be apparent, although the reference attributes can be selected to remain identifiable under various lighting conditions, scaling, and orientations of the item 102, the comparison of current attributes to reference attributes may nevertheless be facilitated by capturing images of the item 102 in similar orientations and at a similar scale as the reference image. In some examples, therefore, image locations (e.g. pixel coordinates or the like) for the vertices of the item 102 from the reference images can be stored in the repository 122 or encoded in the label 420, either as reference attributes or separate, auxiliary attributes. The client device 124 capturing images at block 320 can be configured to retrieve the vertex locations, from the repository 122 or by decoding the label 420. The device 124 can then be configured, as shown in FIG. 5, to present an overlay 500 on the display 236 to guide an operator of the device 124 to adjust the relative positions of the item 102 and device 124, in order to capture an image of the item 102 in a similar orientation as the reference image.

At block 325, the client device 124 can determine current attributes of the item 102 from the current image(s), or provide the current image to the server 120 for determination of current attributes. The determination of current attributes is performed in the same way as the determination of reference attributes at block 310. As will be apparent, therefore, the performance of block 325 yields a vector having the same structure as the vector 412, although not necessarily the same values.

At block 330, the server 120 (or, alternatively, the client device 124 that captured the current image at block 320) is configured to compare the current attributes to the reference attributes, to determine whether the boundary of the item 102 is deformed in its current state, relative to the initial state represented in the reference image.

As will be apparent, therefore, the server 120 is configured to retrieve the reference attributes corresponding to the item 102, e.g., based on the item identifier decoded from the label 420. Comparing reference attributes to current attributes can include determining a cosine similarity, a Euclidian distance, or the like, between the current and reference attributes. The determination at block 330 can include determining whether the distance or any other similarity metric is smaller than a predefined threshold. In other examples, the comparison can include providing the reference attributes and the current attributes to a classifier, such as a trained binary model (e.g., a multi-layer perceptron, a support vector machine, a Random Forest model, or the like). The model may be trained prior to performance of the method 300 by providing labeled pairs of attribute sets (e.g., pairs of attribute sets labeled as matching, and pairs of attribute sets labelled as not matching).

When the determination at block 330 is affirmative, indicating that the visual appearance of the item 102 has not changed to a degree that indicates boundary deformation (i.e., damage to the item 102), the server 120 proceeds to block 335, at which the current attributes are stored in the repository, e.g., as an additional vector along with a timestamp, location, or the like. Thus, the record 416 contains a documented chain of attributes of the item 102, beginning with the reference attributes and including any subsequently captured intermediate attributes. Storage of the current attributes can also include producing an updated label 420 or an additional label, such that both the reference attributes and the current (e.g., the most recent, when multiple sets of current attributes have been obtained) attributes are affixed to the item 102.

Following storage of the current attributes at block 335, the server 120 is configured to determine, at block 340, whether the item has reached its final destination (e.g., the customer residence 106). When the determination at block 340 is affirmative, performance of the method 300 ends. When the determination at block 340 is negative, the performance of blocks 320 to 335 can be repeated one or more times, e.g., at additional intermediate locations as the item 102 is in transit.

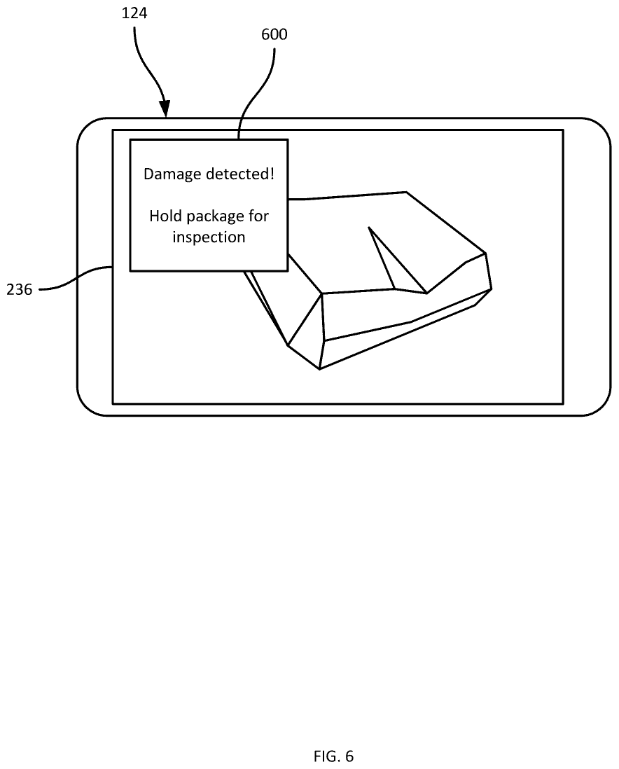

When the determination at block 330 is negative, as a result of differences between the reference attributes and the current attributes sufficient to indicate damage to the item 102, the server 120 proceeds to block 345 rather than block 335. At block 345, the server 120 is configured to generate an exception notification. The exception notification can include a prompt to a client device 124 at the current location of the item 102, e.g., instructing the operator of the client device 124 to initiate an exception handling process for the damaged item, e.g., by transporting the item 102 to an inspection station, instructing the operator to capture images of all faces of the item 102, or the like. FIG. 6 illustrates an example prompt 600 presented by a client device 124 at block 345, e.g., in response to receiving an exception notification from the server 120, or in response to generating the exception notification locally (in examples in which attribute comparisons are performed at the client devices 124).

In other examples, the exception notification can include a control signal to an item handling apparatus, such as a conveyor system or the like. For example, the control signal can result in the item 102 being redirected to an inspection area, for repackaging, or the like. In further examples, the exception notification can include a flag or other indicator stored in the record 416, indicating the location and time at which damage was first detected via attribute comparison.

In further examples, the reference image and/or reference attribute(s) need not correspond to the specific instance of item being tracked. For example, in a system that handles a limited set of receptacle types (e.g., a set of specific boxes), reference images of such receptacles can be captured and stored for use in connection with tracking any future instance of the same receptacle. In still other examples, a reference attribute, such as one or more linear dimensions, can be obtained at block 310 via manual entry at a client device 124.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device of detecting boundary deformation for an item, the method comprising:
obtaining a current image of the item;
obtaining, from the current image, a current attribute of a boundary of the item;
retrieving a reference attribute of the item boundary, the reference attribute corresponding to the item in an initial state;
comparing the current attribute to the reference attribute;
determining, based on the comparison, whether the item boundary is deformed relative to the initial state of the item; and
when the item boundary is deformed, generating an exception notification.

2. The method of claim 1, wherein retrieving the reference attribute includes extracting the reference attribute from a machine-readable indicium affixed to the item.

3. The method of claim 2, wherein the machine-readable indicium includes at least one of a barcode and an RFID tag.

4. The method of claim 1, further comprising, prior to obtaining the current image, generating the reference attribute by:
obtaining a reference image of the item; and
deriving the reference attribute from the image.

5. The method of claim 4, further comprising: storing the reference attribute for subsequent retrieval.

6. The method of claim 5, wherein storing the reference attribute includes: encoding the reference attribute in a machine-readable indicium configured to be affixed to the item.

7. The method of claim 1, further comprising:
storing the current attribute in association with the reference attribute and an identifier of the item.

8. The method of claim 7, wherein storing the current attribute includes encoding the current attribute in a machine-readable indicium to be affixed to the item.

9. The method of claim 1, wherein the exception notification includes a control signal to an item handling apparatus to redirect the item.

10. The method of claim 1, wherein the reference attribute includes at least one of:
a dimension of the item;
a number of edges of the item detected from the image; and
a keypoint descriptor extracted from the image.

11. A computing device, comprising:
a memory; and
a processor configured to:
obtain a current image of the item;
obtain, from the current image, a current attribute of a boundary of the item;
retrieve a reference attribute of the item boundary, the reference attribute corresponding to the item in an initial state;
compare the current attribute to the reference attribute;
determine, based on the comparison, whether the item boundary is deformed relative to the initial state of the item; and
when the item boundary is deformed, generate an exception notification.

12. The computing device of claim 11, wherein the processor is configured, to retrieve the reference attribute, to extract the reference attribute from a machine-readable indicium affixed to the item.

13. The computing device of claim 12, wherein the machine-readable indicium includes at least one of a barcode and an RFID tag.

14. The computing device of claim 11, wherein the processor is configured, prior to obtaining the current image, to generating the reference attribute by:
obtaining a reference image of the item; and
deriving the reference attribute from the image.

15. The computing device of claim 14, wherein the processor is further configured to: store the reference attribute for subsequent retrieval.

16. The computing device of claim 15, wherein the processor is further configured, to store the reference attribute, to: encode the reference attribute in a machine-readable indicium configured to be affixed to the item.

17. The computing device of claim 11, wherein the processor is further configured to:
store the current attribute in association with the reference attribute and an identifier of the item.

18. The computing device of claim 17, wherein the processor is further configured, to store the current attribute, to encode the current attribute in a machine-readable indicium to be affixed to the item.

19. The computing device of claim 11, wherein the exception notification includes a control signal to an item handling apparatus to redirect the item.

20. The computing device of claim 11, wherein the reference attribute includes at least one of:
a dimension of the item;
a number of edges of the item detected from the image; and
a keypoint descriptor extracted from the image.
